(19) United States
(12) Patent Application Publication
(10) Pub. No.: US 2008/0106662 A1
(43) Pub. Date: May 8, 2008

(54) Bistable Liquid Crystal Device

(75) Inventors: Nigel Mottram, Glasgow (GB); Alison Ramage, Glasgow (GB); Gavin Kelly, Glasgow (GB); Andrew Davidson, Glasgow (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: University Of Strathclyde, Glasgow (GB)

(21) Appl. No.: 11/720,494

(22) PCT Filed: Dec. 5, 2005
(86) PCT No.: PCT/GB05/04635

§ 371 Date: Jul. 24, 2007

(30) Foreign Application Priority Data
Dec. 3, 2004 (GB) 0426582.3

(51) Int. Cl. G02F 1/136; G02F 1/1333

(52) U.S. Cl. 349/42; 349/33; 349/84

(57) ABSTRACT

A bistable liquid crystal device having liquid crystal molecules in one or more cavities, at least one liquid crystal region of high distortion being formed in each cavity, these region(s) being switchable between bistable states on application of an electric field. Each cavity may have a polygon cross-section such as a square cross-section.

The present invention relates to a bistable liquid crystal device and a liquid crystal display that includes such a device.

### BACKGROUND

Liquid crystal materials (LCs) consist of rod-like molecules that prefer to align parallel to each other and are capable of being aligned by applied electric fields. The long-range order caused by the local alignment of molecules enables the “director”, the average molecular direction, to be defined. The long and short axes of these molecules exhibit different optical properties and certain molecular orientations can therefore alter the polarisation and intensity of incident light. These reorientation and polarisation effects can be utilised in conjunction with optical elements such as polarising layers to produce optical devices such as optical switches, changeable phase gratings or displays.

Existing LC devices commonly have two transparent substrates, with semi-transparent electrodes that may be patterned into pixels on the inner side of each substrate, sandwiching a liquid crystal (LC) material between them. Optical polarisers are usually placed on the outer surface of each substrate so that the polariser orientations are perpendicular. Between the liquid crystal layer and each electrode/substrate an alignment layer is used to specify the orientation of the LC molecules close to the substrate. Each pixel may be addressed “passively” using a voltage applied across the pixel row and column electrodes or “actively” using thin film transistors to selectively apply an electric field across a single pixel. This electric field may be used to switch the liquid crystal molecules between two orientational states, each with a different effect on the light passing through the LC layer such that, depending on the state, the light may either be transmitted through or blocked by the polariser(s).

One method of achieving this is through the use of twisted nematic configurations. In these devices, alignment layers are used to orient the LC molecules close to opposing substrates in perpendicular directions to each other. In the state where no electric field is applied across a pixel, the perpendicular LC alignment close to the substrates results in a 90° twist in LC orientation as one moves from surface to surface. This has the effect of rotating the polarisation of the light through 90°. When polarisers are placed parallel to the alignment directions at each substrate, incident light becomes initially polarised by the first polariser in one direction, then the polarisation direction of the light is rotated 90° by the LC to coincide with the second polariser at the other substrate, such that light is output from the pixel. Coloured filters may be placed over the pixel to produce coloured pixels. When a voltage is applied between the electrodes of a pixel, the LC aligns with the direction of the field, i.e. perpendicular to the plane of both substrates. In this state, as the LC molecules are aligned parallel to the direction of the propagation of the light, no change in polarisation of the light due to the LC configuration takes place. Thus, polarised light from the first polariser is blocked by the second polariser in the perpendicular direction.

Displays of this type have many advantages such as being very flat, light and robust when compared with other display types such as cathode ray tubes. As such they are ideal for small portable devices such as mobile phones and PDAs. However, they have a high-energy demand due to the need for constant power to be applied to hold a pixel in one state. Furthermore, these displays typically require backlighting from a light source to achieve a bright picture with high contrast, which in turn further increases the power consumption, leading to a shortened battery life. In addition, since these systems employ out of plane switching, where the LC molecules align themselves perpendicularly to the plane of the substrates in the presence of the electric field, birefringence effects can lead to a loss of contrast when viewed from the side. The resultant geometry may also lead to colour distortion due to parallax effects.

Some of the problems associated with the devices described above are addressed by bistable liquid crystal technology. In a bistable liquid crystal device, the LC has more than one stable director configuration. As such, once switched into a stable state, the LC remains in that state until an electric field is applied to change the configuration. This type of operation requires less power since power is only supplied to change states and not supplied continuously to maintain a state.

U.S. Pat. No. 4,333,708 describes an example of a bistable LC device having a number of multistable modes that involve the motion of singular points or “disclinations” lying parallel to the device substrates. EP 0,517,715 and WO92/00546 describe other examples of bistable LC devices, in which surface treatments (evaporation of SiO) are used to produce a bistable surface alignment layer. This surface exhibits two possible director configurations. By switching the director at the surface with the application of a suitable voltage waveform, switching between the two states is possible.

Another bistable device is described in U.S. Pat. No. 5,796,459. This has substrate surfaces that have been treated so that bigratings exist on one or both substrates. This bigrating arrangement creates two different possible angular directions in which the LC molecules can lie. WO 97/14990 describes a further example of a bistable device. This has a surface alignment monograting on at least one of the substrates. The surface monograting has a groove height to width ratio that leads to approximately equal energy for two director alignment arrangements. The director alignment arrangements differ from each other primarily by angle of the director from the plane of the substrate. The device is switched using appropriate voltage pulses.

Yet another approach to producing bistable liquid crystal devices involves having an array of either posts or holes placed on one of the substrates. Devices of this type are described in EP 1,271,225 and EP 1,139,151. The presence of posts or holes allows multiple director orientations to be stable. The difference between the director orientations is primarily in the difference in director angle from the main plane of the substrates. Switching between these states is achieved using appropriate voltage pulses coupling to the molecular dipoles.

In all of the above devices, each stable state has a different effect on the polarisation of light and this can be used in conjunction with suitably oriented polarisers to allow or block the transmittance of light. These systems may be used with light transmitted through the device or reflected from a surface at the back of the device. Variations in surface treatments on the sub-pixel level may be used to achieve greyscale. Whilst these provide some advantages over more conventional arrangements, they suffer from the fact that the switching is out of plane, which can lead to loss of contrast at oblique viewing angles and colour deformations due to parallax errors.

Some of the devices described above may contain LC defect regions. When LCs are enclosed within a container, the molecular direction is influenced by the container surfaces. This can lead to conflicts at certain regions, resulting in defects. In these defect regions, the molecules align themselves in such a fashion so that a high distortion energy structure, associated with a reduction in molecular order, is formed, as discussed by Repnik et al. in European Journal of Physics, Vol. 24, pages 481-492 (2003). Depending on factors such as the dimensions and shape of the container, topography of the surface, temperature, applied electric field and the surface energy of the walls, several configurations of the liquid crystal molecules may be possible. Each configuration may have varying defect positions and alignment of bulk liquid crystal molecules. Defects are, however, generally regarded as undesirable as they lower device efficiency. Hence, in most known devices steps are taken to remove such defects or avoid their formation altogether.

### SUMMARY OF INVENTION

According to a first aspect of the present invention, there is provided a bistable liquid crystal device having a liquid crystal material contained within cavities in a containment structure, the cavities being such that at least one region of high distortion or defect in the ordering of the liquid crystal molecules is formed, the distortion region(s) being switchable between bistable states on application of an electric field.

In contrast to some prior art arrangements, rather than trying to remove defects, the present invention takes advantage of these and uses them to provide bistable states. By applying an appropriate electric field, the distortion region(s) can be switched between these states. This can be done substantially in-plane, thereby avoiding or at least reducing the loss of contrast at oblique viewing.

Means may be provided for applying the electric field as a pulse. Means may be provided for varying the magnitude and duration of that pulse.

The containment structure may have cavities that have a square or polygon cross-section in a plane parallel to the transparent substrates. The angles of the cross-section need not be sharply defined. The cavity walls preferably run substantially perpendicular to a base or substrate of the containment structure. The containment structure may be formed from polymer or photoresist using photolithography.

The liquid crystal molecules and the containment structure are preferably sandwiched between two transparent substrates that may be glass or plastic. The transparent substrates may have semi-transparent or transparent electrodes on either surface. An electrode may be associated with one or more cavities. Electrodes may additionally or alternatively be located on the cavity walls. These electrodes may be such that each electrode may be attached to a switching device. The switching device may contain one or more thin film transistors.

The transparent substrates may be laminated with a polariser layer.

The cavities in the containment structure may be open ended and flush with, or integral with, the transparent substrates or any of the above laminated layers such that the liquid crystals in each cavity are isolated from those in adjoining cavities.

The majority of liquid crystal molecules may lie in a plane substantially parallel with the planes of the transparent substrates. In one embodiment, stable states of equal energy are formed such that any stable state may be obtained from any other stable state by rotation about an axis perpendicular to the substrates.

The surface of one of the substrates may be such that LC molecules are fixed to the surface, resulting in the LC in at least one of the stable states being in a twisted configuration. In this embodiment, the LC molecules may be chiral or an achiral liquid crystal may be doped with chiral molecules in order to achieve similar stabilities of the twisted and non-twisted configurations, thus enabling efficient switching.

According to another aspect of the invention, there is provided a method of switching states in a liquid crystal device containing liquid crystal molecules within a cavity in a containment structure, the cavity being such that at least one high distortion region is formed, the method comprising applying an electric field in order to switch from a first bistable state to a second bistable state by motion of defects. The electric field may be parallel to the liquid crystal molecules or contain a component parallel to those molecules in order to effect in-plane switching.

Preferably, switching is between two states having similar or identical energies.

The device and method of the current invention may be used for various applications including a display substrate, a phase device for telecommunications, an optical switch or a changeable phase grating.

### BRIEF DESCRIPTION OF THE DRAWINGS

Various aspects of the invention will now be described by way of example only and with reference to the accompanying drawings of which:

FIG. 1(a) is an expanded view of a liquid crystal device;

FIG. 1(b) is a cross section through the expanded view of FIG. 1(a);

FIG. 2 is a representation of the alignment of liquid crystal molecules in a stable state in a cavity of the device of FIG. 1;

FIG. 3 is a representation of the alignment of liquid crystal molecules in a different stable state in a cavity of the device of FIG. 1;

FIG. 4 is a representation of a cavity in which the liquid crystal molecules are in a twisted state;

FIG. 5 is a representation of the cavity of FIG. 4, in which the liquid crystal molecules have been switched to a uniform state, and

FIG. 6 is a plot of simulated elastic energy as a function of time as the liquid crystal configuration within three different cavity shapes is switched using the same voltage pulse.

### SPECIFIC DESCRIPTION

Containing liquid crystals within containment structures having certain shapes and dimensions can lead to the tendency of the liquid crystals to arrange themselves into one of a multiple of stable states, each stable state having differing director structures and possibly different locations of regions of high distortion. A high distortion 3 0 location is a region where the liquid crystal molecular order is significantly reduced compared to the bulk and a large elastic distortion occurs, as discussed by Repnik et al. in European Journal of Physics, Vol. 24, pages 481-492 (2003).

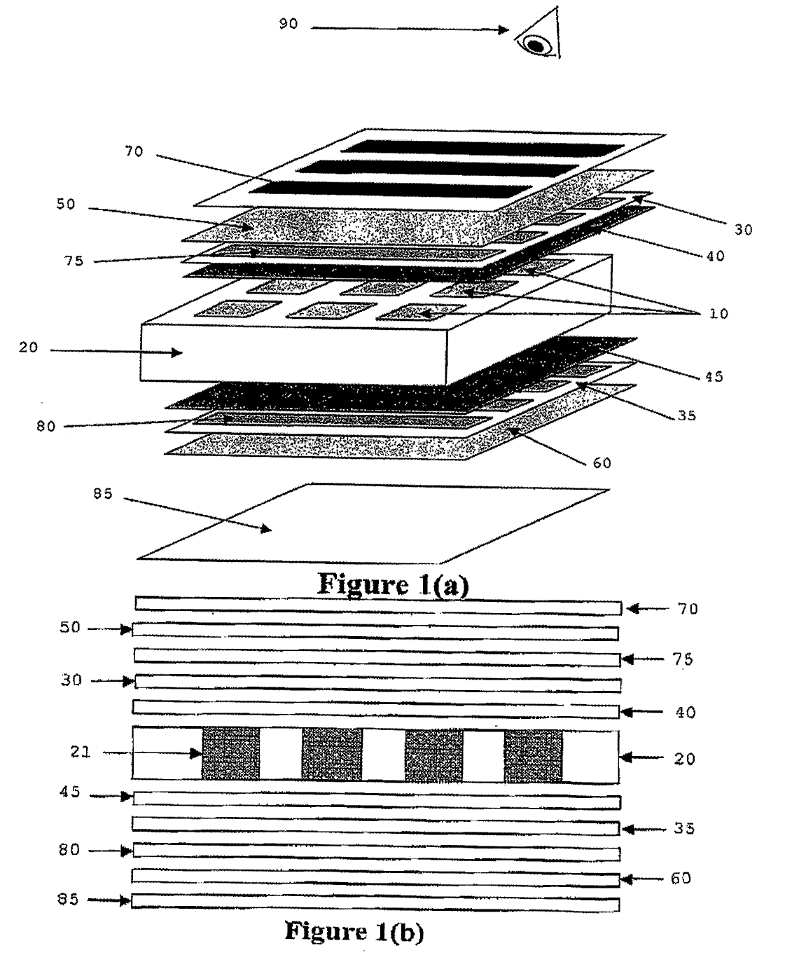

FIGS. 1(a) and (b) show a liquid crystal device having a liquid crystal material 10 contained within a containment structure 20 that defines a plurality of openings 21. The containment structure 20 is sandwiched between two transparent substrates 30, 35, which may have alignment layer preparations 40, 45 adhered to faces in contact with the liquid crystal material 10. The containment structure 20 and the substrates 30, 35 together define a plurality of cavities for containing the liquid crystal material 10. The liquid crystal material 10 within each cavity completely fills it, so that the liquid crystal material is in direct contact with all of the cavity walls/surfaces.

Polarisers 50, 60 are laminated to the outside of both transparent substrates 30, 35 and a colour filter 70 may be located over the outside of the outer transparent substrate 30. The colour filter 70 may be provided as a series of strips or squares of transparent coloured sections. Each cavity may have an area of colour filter 70 associated with it. Each colour filter may cover several cavities. The colour filter 70 may have red, green and blue transparent coloured sections.

The cavities of the containment structure 20 in this case have an approximately square cross section having sharp or rounded corners 120, 130, 140, 150 in a plane parallel to the transparent substrates 30, 35. In other embodiments, the cross section of the cavities may be any polygon with sharply defined corners. The length of the sides of the square cross section of the cavity may be between 10 and 100 μm long and the cavity should be between 1 and 50 μm deep.

On their surfaces and facing the liquid crystals 10, the transparent substrates 30, 35 have patterned transparent electrodes 75, 80 formed for example from a thin layer of Indium Tin Oxide. To achieve in-plane switching, these electrodes 75, 80 are used to produce an electric field with a component in a plane parallel to that of the transparent substrates 30, 35. This may be achieved for example by having electrodes staggered so that the counter electrode is not directly below the working electrode. Alternatively or additionally, electrodes may be incorporated into the cavity walls in order to produce an electric field parallel to the substrate. Each electrode may be associated with one or more cavities and there may be more than one set of electrodes to enable switching between the two or more stable states. A light source 85 is located at the rear of the device and the light is detected 90 or the picture viewed at the opposite side of the device from the light source 85. The cavities in the containment structure 20 and associated electrodes 75, 80 may correspond to a pixel of a displayed image or several cavities and electrodes 75, 80 may correspond to one pixel in order to achieve a greyscale or full colour output.

The alignment of the liquid crystal molecules 10 on the containment structure 20 walls is dictated by a number of factors. For example, when the containment structure 20 is made of a polymeric material the polymer direction dictates the molecule direction. Alternatively, when a photoresist material such as SU8 is used to create the containment structure 20 the molecules prefer to lie in any direction parallel to the surface. As yet a further alternative, when a homeotropic alignment surface treatment is used the molecules prefer to lie perpendicular to the cavity surfaces with the molecules preferring parallel alignment at the transparent substrates 30, 35.

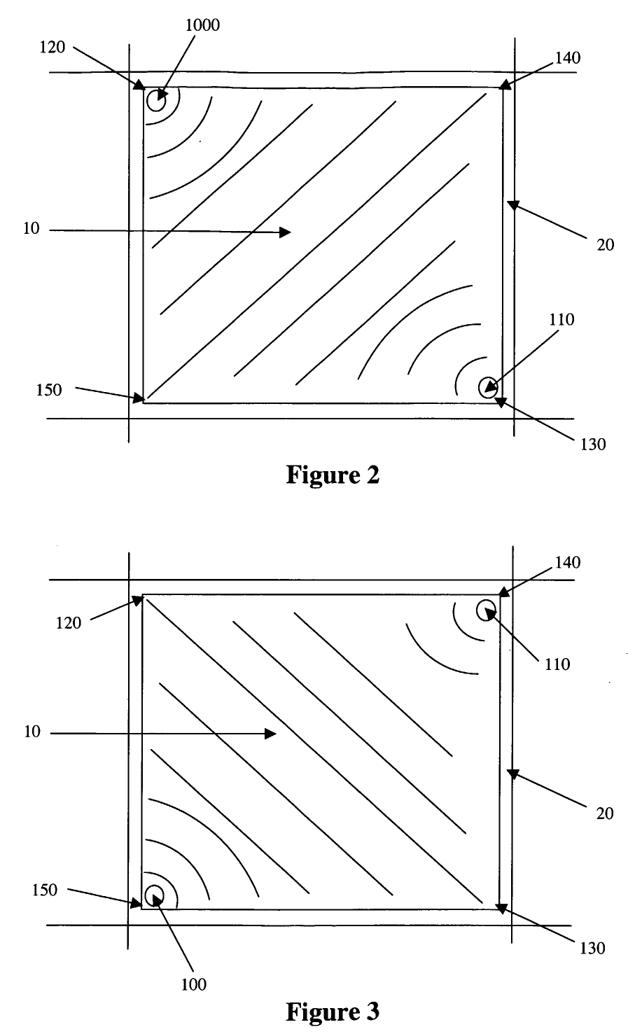

As shown in FIG. 2, for cubic cavities and for a homeotropic alignment of the liquid crystal molecules 10 at the walls of the containment structure 20 and planar alignment at the transparent substrates 30, 35, the liquid crystal molecules 10 in the bulk of the region tend to align themselves at 45° to the sidewalls of the cavities and in a plane parallel to the transparent substrates 30, 35. To accommodate this preferred alignment of the liquid crystal molecules 10, high distortion regions 100, 110 form at two diagonally, opposing corners of the cavity 120, 130. The relatively sharp transition between adjoining walls of the cavity is advantageous in promoting the formation of localised high distortion regions and pinning these regions to the corners 120, 130 of the cavity. The liquid crystal molecules 10 in the region of these high distortion sites 100, 110 are oriented differently to the majority of liquid crystal molecules 10 in the bulk. The further a LC molecule is from the high distortion site, the more its orientation is similar to those of the bulk, i.e. at 45° to the walls of the cavity.

As shown in FIG. 3, application of a suitable electric field having a component in the plane of the direction of the liquid crystal molecules 10 results in the high distortion regions 100, 110 moving, in this case switching between being located at corners 120 and 130 of the cavity to being located at corners 140 and 150 of the cavity. The bulk LC molecules 10 re-align themselves to match the change in location of the high distortion regions such that they lie 900 to their previous direction but still lying at 45° to the containment walls 20 and in a plane parallel to that of the transparent substrates 30, 35. Thus the switching remains in-plane, i.e. the bulk liquid crystal molecules 10 always lie in a plane parallel to that of the substrates 30, 35. This has advantages in that it allows for a wide range of viewing angles due to the absence of birefringence effects and provides a high degree of contrast due to its 90° switching between states.

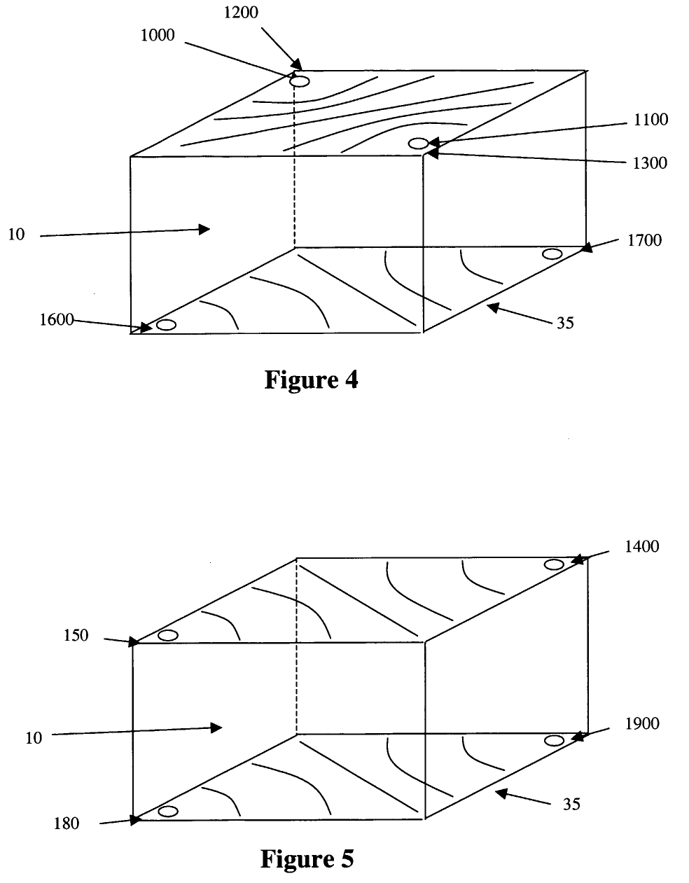

Amongst the possible devices to utilise these bistable states and the switching mechanism are devices that switch between uniform structures, where the whole liquid crystal structure switches between the orientations in FIG. 2 and FIG. 3, by 90°, or devices that switch between a uniform structure and a twisted structure as in FIG. 4 and FIG. 5. In the latter example, the LC molecules on one of the transparent substrates 35 are fixed so permitting the possibility of a twisted structure. In the twisted state in FIG. 4 the high distortion regions 100, 110 run from corners 120 and 130 at the upper surface of the cavity to corners 160, 170 at the lower surface of the cavity. The molecular configuration is therefore twisted from the top to the bottom cavity. In the undistorted state in FIG. 5 the high distortion regions 100, 110 run from corners 140, 150 to 180, 190 and the molecular configuration is not twisted. Devices that allow switching between uniform structures would be ideal for a phase device used in telecommunication switches. The second device which switches between a uniform and a twisted structure would be ideal for a display device and would lead to a bistable, in-plane version of the standard Twisted Nematic display. In this latter case, some degree of chirality may be included through chiral nematic LC molecules or a chiral dopant.

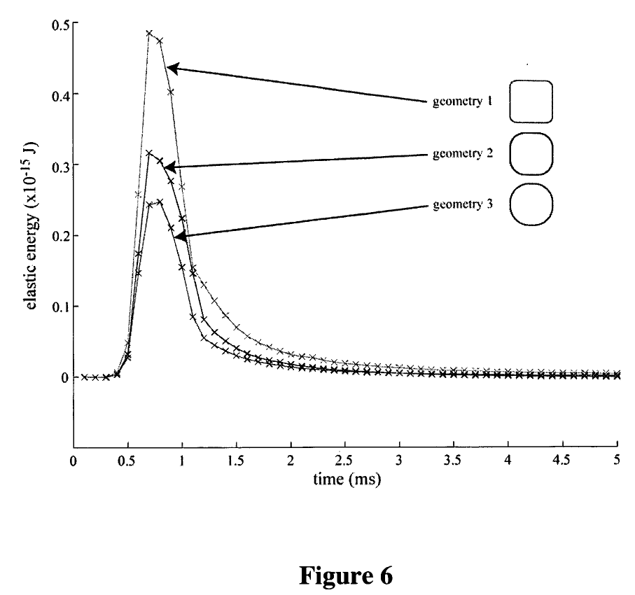

The sharpness of the corners of the cavity determines both the stability of the different states, where the high distortion regions are located at different corners, and the voltage needed to switch the device between states. For sharper corners the elastic energy barrier between two different molecular configurations is high compared to smoother corners. The increase in the energy barrier both increases the stability of the two states and increases the voltage needed to switch between the two states. The increased energy barrier is seen in FIG. 6, which shows the simulated elastic energy as a function of time as the liquid crystal configuration within three different cavity shapes is switched using the same voltage pulse. In the cavity with the sharpest corners the elastic energy increases more during the switch than for the cavity with the almost circular cavity.

The device in which the invention is embodied provides numerous advantages. For example, the 90° switching permits the use of only one polarising layer 50, possibly with the use of a pleochroic dye dissolved in the LC, which increases the brightness of the output light. Furthermore, the device is less susceptible than conventional arrangements to damage due to knocks and vibrations. In addition, the current method allows for the use of two stable uniform states that are mirror images of each other and thus have identical energies. This allows easier switching between the two states. In the embodiment containing a twisted structure, chiral molecules can be used so that the two states, twisted and uniform, have almost equal energy, thus allowing easier switching between states.

Using the device and method of the current invention, it is possible to achieve a rugged device having a good contrast, a wide range of viewing angles with good optical characteristics, a range of greyscales or full colour, 90° rotation of light between states and low power consumption. These properties make the present invention particularly useful in optical switches, LC displays and variable phase gratings. LC displays in accordance with the present invention are particularly suitable as electronic paper or displays in portable devices due to the good contrast, wide viewing angle, low power consumption and their ability to use passive addressing and therefore allow the use of significantly more pixels than in current devices.

A skilled person will appreciate that variations of the disclosed arrangements are possible without departing from the invention. For example, in the embodiment described above, light is transmitted through the device. However, in another embodiment, the substrate at the back 35 may be reflective and the light may be shone from the front of the device. Alternatively, ambient light may be used. Also, in order to minimise diffraction effects, the cavities within the containment structure 20 may be randomly arranged. Alternately, if diffraction effects are required, the cavities can be arranged in orderly fashion, such as an M by N grid, so as to achieve the required diffraction effect, as is known in the art. Furthermore, whilst in the device described with reference to FIGS. 2 and 3, a homeotropic alignment surface treatment is applied to the walls of the cavities and the material of the transparent substrates 30, 35 is selected so that liquid crystals in contact with them tend to align in a direction parallel thereto, it will be appreciated that a homogeneous or planar degenerate alignment technique could be used on the cavity walls so that at least some of the liquid crystal molecules lie in, and can be rotated in a plane perpendicular to the propagation of light. Accordingly the above description of the specific embodiment is made by way of example only and not for the purposes of limitation. It will be clear to the skilled person that minor modifications may be made without significant changes to the operation described.

1. A bistable liquid crystal device having liquid crystal molecules in one or more cavities, at least one liquid crystal region of high distortion being formed in each cavity, each region being switchable between bistable states upon application of an electric field.

2. A bistable liquid crystal device according to claim 1 wherein each cavity has a polygon cross-section.

3. A bistable liquid crystal device according to claim 1 wherein there is a sharp transition between adjoining cavity walls.

4. A bistable liquid crystal device according to claim 1 wherein walls that define the cavities are substantially perpendicular to a base or substrate.

5. A bistable liquid crystal device according to claim 1 wherein the high distortion regions are located at corners of the cavities.

6. A bistable liquid crystal device according to claim 1 wherein the liquid crystal molecules lie in a plane substantially parallel to a base of the cavity.

7. A bistable liquid crystal device as claimed in claim 1 wherein the liquid crystal molecules are chiral.

8. A bistable liquid crystal device as claimed in claim 1 wherein the liquid crystal material is doped with a chiral additive.

9. A bistable liquid crystal device according to claim 1 wherein the liquid crystal molecules in each cavity are isolated from hose in adjoining cavities.

10. A bistable liquid crystal device according to claim 1 where the liquid crystal device is a nematic liquid crystal device.

11. A bistable liquid crystal device according to claim 1, further comprising means for applying at least a component of an electric field in a plane parallel to at least some of the liquid crystal molecules.

12. A bistable liquid crystal device according to claim 1 wherein the liquid crystal molecules and a containment structure are sandwiched between two transparent substrates.

13. A bistable liquid crystal device according to claim 1 wherein electrodes are located on the cavity walls of the cavities.

14. A bistable liquid crystal device according to claim 1 where a containment structure is formed from a photoresist or polymeric material.

15. A bistable liquid crystal device according to claim 1 where at least one electrode is associated with one or more cavities, and attached to a switching device.

16. A bistable liquid crystal device according to claim 15 where the switching device contains one or more thin film transistors.

17. A bistable liquid crystal device according to claim 1 where the device has at least one polariser layer.

18. A display device that includes a bistable liquid crystal device according to claim 1.

19. A phase device for telecommunications that includes a bistable liquid crystal device according to claim 1.

20. An optical switch that includes a bistable liquid crystal device according to claim 1.

21. A changeable phase grating that includes a bistable liquid crystal device according to claim 1.

22. A method of switching states in a liquid crystal device containing liquid crystal molecules within a cavity in a containment structure, the cavity being such that at least one localised region of high distortion is formed, the method comprising applying an electric field to the molecules in order to switch the high distortion region from a first one of bistable states to a second one of the bistable states.

23. A method as claimed in claim 22 wherein the electric field applied has a component that is substantially parallel to a plane in which the liquid crystal molecules lie.
